(19) United States
(12) Patent Application Publication
(10) Pub. No.: US 2008/0079177 A1
(43) Pub. Date: Apr. 3, 2008

(54) Humidifier

(75) Inventor: Daniel E. Schuld, Inverness, IL (US)

Correspondence Address: GREER, BURNS & CRAIN, 300 S WACKER DR, 25TH FLOOR, CHICAGO, IL, 60606, US

(73) Assignee: RPS Products, Inc.

(21) Appl. No.: 11/540,801

(22) Filed: Sep. 29, 2006

(51) Int. Cl. B01F 3/04

(52) U.S. Cl. 261/24; 261/DIG. 15

(57) ABSTRACT

Apparatus for and a process of making and stocking humidifiers for hot air heating systems resides in providing a selected number of humidifier modules of the bypass type, providing a lesser number of power modules each having a motor driven fan, employing the humidifier modules alone in heating systems calling for a bypass humidifier, and optionally combining a power module with a humidifier module for converting the humidifier to a powered humidifier for heating systems calling for a powered humidifier. Optional control modules may also be provided and employed as needed. The modules are assembled side by side. The process and apparatus eliminate the need for manufacture, stocking and supply of two different styles of hot air furnace humidifiers, i.e., bypass humidifiers and powered humidifiers, inasmuch as a single humidifier module now suffices. Substantial convenience, economy and cost savings are thereby realized.

### FIELD OF THE INVENTION

The present invention relates to humidifiers, particularly humidifiers for hot air furnaces and heating systems.

### BACKGROUND

Humidifiers for hot air furnaces and space heating systems are typically comprised of a housing having an air inlet and an air outlet for passing space heating air from the furnace through the housing and over and/or through a water fed evaporator in the housing for moistening the heating air passing through the housing and to the space heating system. The structure, mode of operation and beneficial effects of hot air furnace humidifiers are well known.

The humidifiers are comprised basically of two types, namely, the bypass humidifier and the powered humidifier, i.e., a humidifier that includes a motor operated fan for inducing airflow through the humidifier housing and the evaporator.

A typical bypass humidifier installation is illustrated schematically in accompanying FIGS. 1 in association with a hot air furnace 1 having warm or hot air supply ducting 2, cool or cold air return ducting 3 and an internal blower (not shown) for forcing heated air from the furnace 1 through the ducting 2, to a space to be heated and for pulling or drawing cool air from said space through the ducting 3 back to the furnace to be reheated and re-circulated through the space. A bypass humidifier 4 has an inlet 5 in its back wall connected in fluid (gaseous) communication with one or the other of the ducts 2 and 3, usually the hot air supply ducting 2, and an outlet 6 connected in fluid (gaseous) communication with the other of the ducts, usually the cool air return ducting 3. Due to the differential between the relatively higher pressure airflow in the supply ducting 2 and the relatively lower pressure airflow in the ducting 3, air is induced to flow from the supply ducting 2 through the humidifier 4 to the return ducting 3, thereby causing air to flow over and/or through an evaporator unit 7 in the housing 4 to moisturize, i.e., humidify, the air flowing through the space heating system. A damper 8 installed at the outlet 6 of the humidifier controls the amount of air passing through the humidifier 4 and thus the amount of moisturized air delivered to the space to be heated.

A typical powered humidifier installation is illustrated schematically in accompanying FIGS. 2 in association with a hot air furnace la having hot air supply ducting 2a, cold air return ducting 3a and a self contained blower (not shown) for forcing heated air through the ducting 2a to a space to be heated and for pulling or drawing cool air from such space through the return ducting 3a back to the furnace to be reheated and re-circulated through said space. A powered humidifier 4a, including a motor driven fan 9 is mounted on and connected with one of the ducts 2a and 3a, usually the hot air supply ducting 2a. The humidifier has internal partitions and one or more openings in its rear wall defining one or more inlets 5a to and one or more outlets 6a from the fan 9. Typically, the humidifier 4a includes a moveable or removable cover or front wall 9a for accommodating access to and replacement of the water bearing media or filter pad employed in evaporative unit 7a. The motor driven fan 9 is customarily mounted on and movable with the cover 9a. Motor driven fan 9 is required for the powered humidifier 4a in order to draw some of the heated air from the duct 2a through the inlets 5a, to force that air over and through evaporator unit 7a to moisturize the air, and to force the moisturized air through the fan outlet 6a back into the supply duct 2a.

Due to the wide variety of hot air heating systems available, both for home and commercial heating installations, the bypass humidifier is suitable for some systems and/or installations, but not for others. Similarly, the powered humidifier is suitable for some systems and/or installations, but not for others. The current state of the art requires the existence of two types of hot air furnace humidifiers, the bypass humidifier and the powered humidifier.

Manufacturers are thus required to make two different types of humidifiers; distributors, supply houses and stores are required to stock two different types of humidifiers; and installers and repair personnel are required to stock and carry on their customer service vehicles or trucks the two types of humidifiers.

### SUMMARY

One object of the present invention is to eliminate the need for two different types of humidifiers for hot air furnaces.

Further, it is an object of the invention to provide a hot air furnace humidifier comprised of a bypass humidifier and a method and a kit for converting the bypass humidifier to a powered humidifier.

It is more particularly an object of the invention to provide a hot air humidifier consisting essentially of a single humidifier module usable per se as a bypass humidifier and a selectively usable conversion module, namely a power module, optionally connectable to the humidifier module, for converting the humidifier module from a bypass humidifier to a powered humidifier.

Yet another object of the invention is to provide a powered humidifier wherein the motor driven fan is mounted on the humidifier housing or base along side the evaporative unit, rather than on the humidifier cover, thereby to eliminate the inconvenience, bulk and awkwardness of current cover mounted fan designs.

In accordance with the invention, two compatible modular units are provided. The first unit or module, herein called the humidifier module, is essentially a bypass humidifier comprised of a housing having an air inlet and an air outlet and a water fed evaporator mounted in the housing in such manner that airflow from the inlet to the outlet is compelled to pass over and/or through the evaporator unit as required by the evaporator design. The second unit or module, herein called the power module, comprises a housing having an air inlet, an air outlet and a motor driven fan in the housing for inducing air to flow from the air inlet to the air outlet.

The inlet of the power module is adapted for connection in fluid (gaseous) communication with the outlet of the humidifier module for pulling or drawing air from a furnace air duct through the humidifier and forcing moisturized (humidified) air back into the furnace air duct, preferably the same duct. Alternatively, the power module outlet maybe connected to the humidifier module inlet for forcing air through the humidifier module. In either case, only one style or type of humidifier module is required.

In accordance with the method of the invention, the humidifier module will be provided, i.e., made and/or stocked, in a number needed to meet the total market demand for humidifiers, i.e., the demand for both bypass humidifiers and powered humidifiers; and the power unit or module will be provided, i.e., made and/or stocked, in a smaller number, i.e., only the number needed to meet market demand for powered humidifiers.

The housings of the two modules are of compatible and mating design and the power module is optionally mountable on or connectable with the humidifier module to impart the appearance of a unitary product. The humidifier module is thus directly usable by itself as a bypass humidifier, and is quickly, easily and economically converted from operation as a bypass humidifier to operation as a powered humidifier.

Manufacturers, suppliers, stores, installers and repair personnel thus need, make and/or stock only one type of hot air furnace humidifier and, in a much smaller number, power module kits for converting bypass humidifier modules to powered humidifiers. This results in substantial costs savings and other economies at all levels in the channels of trade from manufacture to the ultimate consumer.

In a further embodiment of the invention, an optional control module is provided, particularly for use with the humidifier in its powered mode of operation. The control module appropriately houses temperature and humidity responsive devices for controlling the supply of water to the evaporator unit and for controlling operation of the motor driven fan, i.e., for turning the fan on and off and/or controlling the speed of the fan. The control module is optional, for use when relatively precise humidity control is desired, thus further contributing to the cost savings and market efficiencies provided by the invention.

Additionally, the power module, and the control module if used, are attached respectively to the side walls or base of the humidifier housing along side the evaporative unit, thereby enabling an unobstructed (i.e., motorless) independently moveable or removable front wall or cover for the humidifier, thereby facilitating ease of access to and replacement of the evaporative medium or filter pad.

These and other objects and advantages of the invention will become apparent to those of reasonable skill in the art from the following detailed description as considered in conjunction with the accompanying drawings.

### IN THE DRAWINGS

FIG. 1A is a fragmentary and schematic illustration in plan view of a hot air heating system utilizing a bypass humidifier;

FIG. 1B is a fragmentary and schematic illustration in elevation of the heating system of FIG. 1A;

FIG. 2A is a fragmentary and schematic illustration in plan view of a hot air heating system utilizing a powered humidifier;

FIG. 2B is a fragmentary and schematic illustration in elevation of the heating system of FIG. 2A;

FIG. 3 is a perspective view of a hot air furnace bypass humidifier provided as a humidifier module in accordance with the invention;

FIG. 4 is a perspective view of a motor driven fan assembly provided as a power module in accordance with the invention;

FIG. 5 is a perspective view of a humidifier control module provided in accordance with the invention;

FIG. 6 is a perspective view from the top right showing the power module of FIG. 4 assembled with the humidifier module of FIG. 3 to comprise a powered hot air furnace humidifier in accordance with the invention;

FIG. 7 is a perspective view from the left showing the power module of FIG. 4 and the control module of FIG. 5 assembled with the humidifier module of FIG. 3 to comprise a second embodiment of a powered humidifier provided in accordance with the invention;

FIG. 8 is a front elevation of the powered humidifier of FIG. 7 showing the same with the front walls or covers of the humidifier and power modules removed;

FIG. 9 is a perspective view from the left of the powered humidifier as illustrated in FIG. 8; and

FIG. 10 is a perspective view from the top right of the powered humidifier as illustrated in FIG. 8.

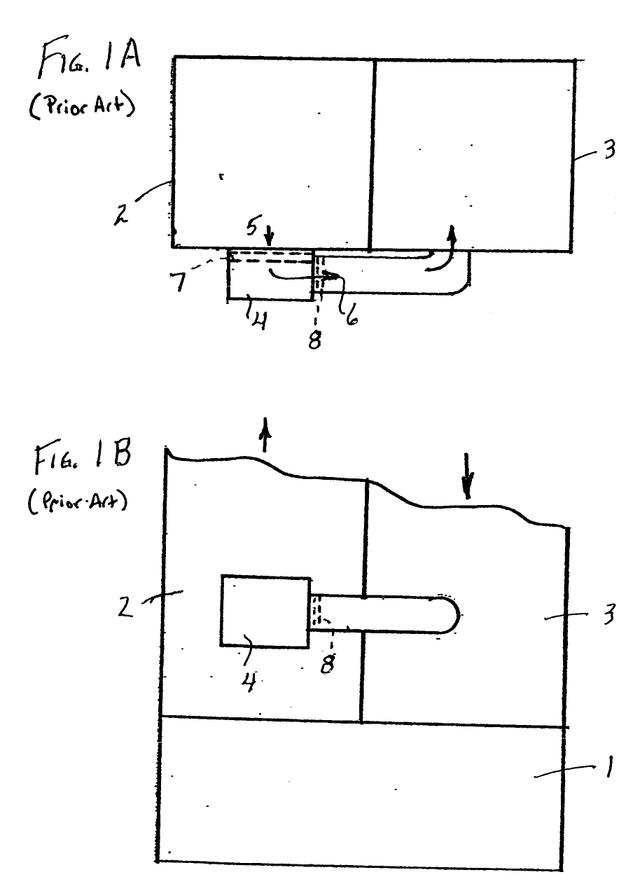

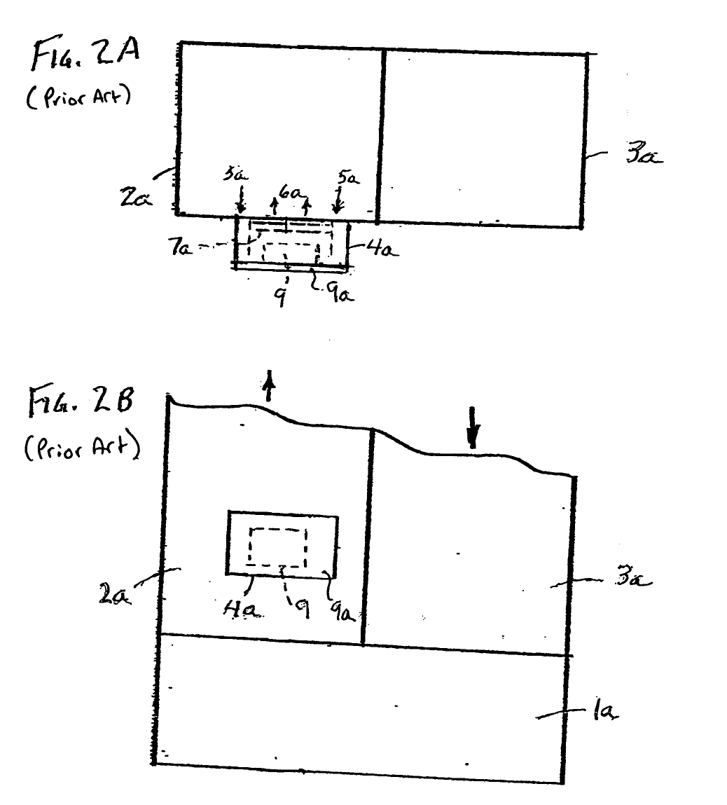

### DETAILED DESCRIPTION

The following is a detailed description of certain embodiments of the invention presently deemed by the inventor to be the best mode of carrying out his invention.

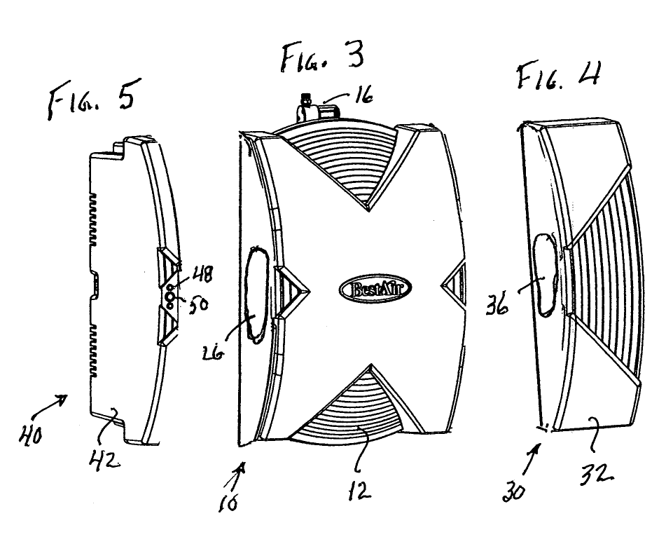

Referring to the drawings; FIGS. 3, 8, 9 and 10 illustrate a humidifier module 10 comprised of a housing 12 containing therein an evaporator unit or assembly 14.

An exemplary evaporator 14 is comprised of a solenoid operated water valve 16 at the top of the housing 12, a header tray or distributor 18 for receiving water from the valve 16 and distributing it uniformly onto the upper marginal portions of an evaporative element 20, a collector tray 22 for collecting excess water from the filter element 20, and a drain 24 leading from the tray 22 to a suitable location for disposal of excess water. The evaporative elements are well known in the art, for example slit and expanded metal pads that provides an evaporative surface for air flowing through the element. Alternative evaporators may be used, including wicking types, For the purposes of this application, the term “evaporator” includes all devices for evaporating water to provide humidification.

An inlet port, hole or aperture (not shown) is formed in the back wall of the housing 12 to accommodate the flow of air from the hot air duct or plenum into the housing and through the moistened filter element 20 to add moisture to and increase the humidity of the air passing through the filter.

To accommodate egress of moisturized air from the housing 12 in the direction best suited for a particular heating system, thereby to meet the requirements of the variety of heating systems encountered in the trade, the housing 12 has a first air port 26 in one side wall and a second air port 28 in its other side wall. Depending on the requisite direction of egress of moisturized air, one of the ports 26 and 28 comprises an air outlet from the housing 12 and the other of the ports 26 and 28 is capped or blocked off to preserve the integrity of the path of air flow through the humidifier module. For example, in a bypass humidifier installation, the right hand port 28 in the housing 12 would comprise the humidifier air outlet and the left hand port 26 would be capped by a suitable closure plate or the like (not shown). In a powered humidifier installation, the power module could be coupled to either the left hand port 26 or the right hand port 28 in housing 12 and that other port 28 or 26 would be blocked by a closure plate or a control module to be described below.

The evaporator unit or assembly 14 may be of any design conventional in the art. Essentially, an evaporator unit or assembly comprises means (valve 16) for supplying water to the housing 12 and one or more water evaporative elements 20 so designed and so mounted and disposed within and relative to the housing 12 that air entering through the inlet port and exiting through the outlet port is compelled to flow over and/or through the element 20. The element 20 is typically saturated with water so that the air passing over and/or through the element 20 will be moisturized and the air exiting the housing 12 will be at a higher humidity then the air entering the housing.

To the extent thus far described, the humidifier module 10 comprises a bypass humidifier adapted to be installed in a hot air heating system. The inlet port in the back wall of the housing 12 is connected in gaseous communication with one of the hot air supply or cold air return ducts and the selected outlet port 26 or 28 is connected in gaseous communication with the other of the hot air supply or cold air return ducts of the furnace. Due to the pressure differential between the furnace air in the supply ducts and the furnace air in the return ducts some of the total heating system airflow will be diverted, i.e., will bypass, from the supply duct to the return duct through the humidifier 10 for adding moisture to the warm or heated air from the furnace. Depending on the specific design of the air moistening element or elements 20, optimum results will usually and preferably be obtained by connecting the air inlet port in gaseous communication with the furnace air supply duct and by connecting the air outlet port in gaseous communication with the furnace return air duct. To control the amount or degree of air flow through the humidifier, a damper of conventional design is preferably mounted adjacent the air outlet port 26 or 28.

The module 10 is thus usable per se, i.e., by itself, as a bypass humidifier.

Where a particular hot air heating system or furnace is not designed for or is not optimally suited for the use of a bypass humidifier, the present invention provides an optional attachment for converting the module 10 from operation as a bypass humidifier to operation as a powered humidifier.

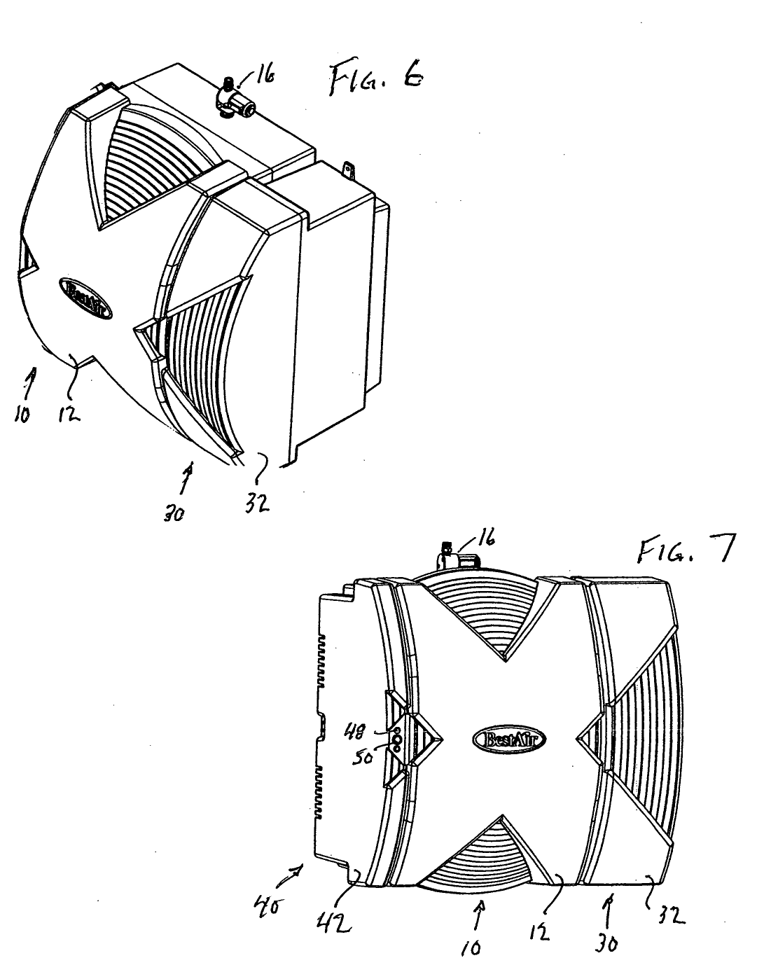

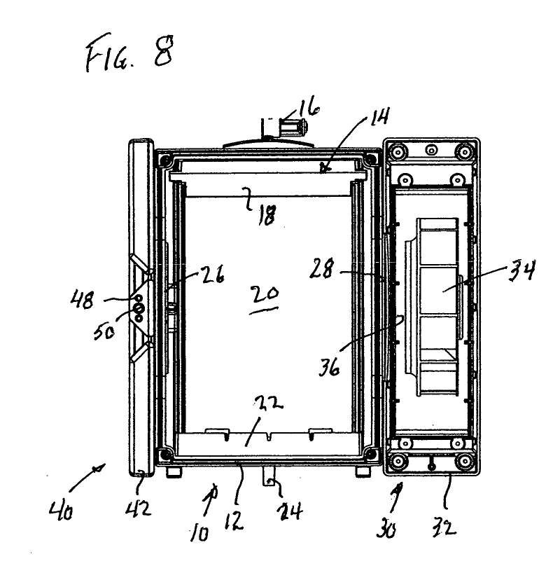

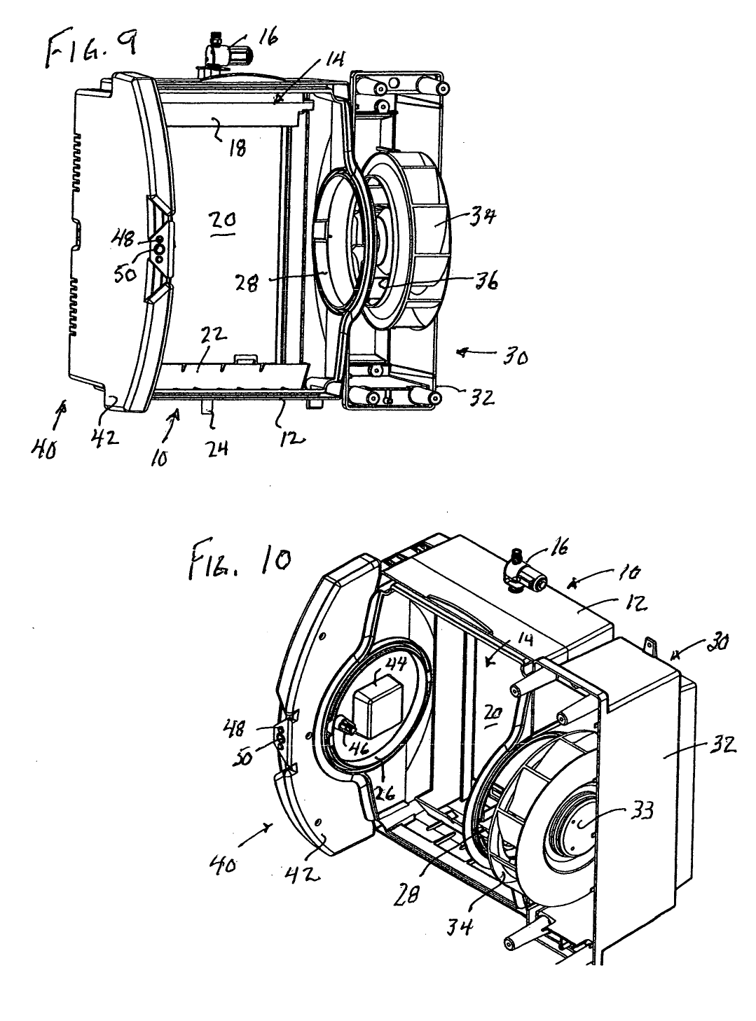

Referring to FIGS. 4 and 6-10, a power module 30 for optional attachment to the module 10 is comprised of a housing 32, an electric motor 33 mounted within the housing and a fan 34, suitably a centrifugal fan mounted concentrically about the motor 33. The fan is operatively associated with the motor and so mounted and disposed within and relative to the housing 32 as to induce and compel air to flow from an air inlet 36 in one side wall of the housing, into and through the housing and to exit through an air outlet (not shown) in the rear or back wall of the housing.

The power module 30 is invertible, that is, it may be inverted from a first position wherein the air inlet 36 is located at the right side of the housing 32 to a second position wherein the air inlet 36 is located at the left side of the housing 32. Consequently, the module 30 can be assembled either to the left side of the module 10, with the air inlet 36 of the module 30 in alignment and gaseous communication with the port 26 on the left hand side of the module 10; or the module 30 can be inverted and mounted on the right side of the module 10 with the air inlet 36 in alignment and fluid communication with the port 28 on the right hand side of the module 10. The modules 10 and 30 thus accommodate ambidextrous assembly of the modules, with the powered module on either the right side of the humidifier module or on the left side of the humidifier module, as may be needed for particular installations.

In both of its alternative locations, the motor driven fan is mounted at the side of the humidifier, thus leaving the front wall or cover unobstructed and uncluttered, so that the wall or cover may easily, independently and conveniently be moved or removed for ease of access to and replacement of the pad or medium 20.

The housing 12 of the module 10 is of a particular size, configuration and design to accommodate the contained evaporator 14 and to impart a pleasing and desirable appearance to the exterior of the module 10. The housing 32 of the module 30 is preferably of a size, configuration and design compatible with and complementary to that of the housing 12 so that when the two modules are assembled with one another as illustrated in FIG. 6, they will convey the appearance of a unitary product of esthically pleasing design.

As illustrated in FIG. 8, the housing 32 of the module 30 is adapted to be attached and secured to the housing 12 of the module 10 in any conventional manner, e.g., by a series of bolts or similar fasteners (not shown). The housing of each module preferably comprises a base adapted for attachment to a furnace and/or another module and a cover. The cover is at least partially removable from the base to provide access to the module for service, such as replacing the evaporative element in humidifier module 10. As shown in FIGS. 8-10, the base of module 30 is secured to the base of module 10 without obstructing the covers of either module. Because the power module is not attached to the humidifier module cover, the cover may easily be lifted or removed from it s base.

The housing 32 is assembled with the housing 12 so that the air inlet 36 of housing 32 is in fluid communication with one or the other of the air outlet ports 26 and 28 in the housing 10. The assembled modules 10 and 30 thus comprise a powered humidifier wherein air is compelled by the fan 34 to flow through the inlet port in the back wall of the housing 12, into the housing, over and/or through the evaporative element 20, into the housing 32 and out through the exit port in the back wall of the housing 32.

Where conditions so indicate, the powered humidifier of FIGS. 5 and 6 can be used in lieu of a bypass humidifier. A powered humidifier comprised of modules 10 and 30 will customarily be connected in communication with either the hot air supply duct or the cold air return duct, usually the hot air supply duct. The inlet port in the back wall of the module 10 will be connected to the duct at a first location and the outlet in the back wall of the module 30 will be connected to the duct at a second location. The two locations can be side by side and together comprise one opening in the duct. When operational, furnace air will be compelled by the fan in the power module to flow through the humidifier module 10 and evaporative element 20 to add moisture to the air that is conducted to the space to be heated, thereby increasing the humidity of the air within such space.

The invention thus provides a universal humidifier for use with all hot air heating systems, whether a given system calls for a bypass humidifier or a powered humidifier. In both cases, air flow is accommodated either from left to right or from right to left.

Manufacturers, suppliers, stores, installers and repair personnel thus need make, stock and carry only a single humidifier. The singular humidifier module 10 is made and stocked in a number adequate to meet total humidifier demand and the power module 30 need be made and stocked only in a number (a significantly lesser number) adequate to meet the demand for powered humidifiers. Substantial advantages, economies and costs savings are consequently realized in all stages of the channels of trade, from manufacturer to consumer.

For some hot air furnace humidifier systems and/or installations it may prove desirable to provide means for controlling the delivery of water to the evaporator unit or assembly 14 and/or for controlling the times and duration of operation and/or the speed of operation of the motor driven fan 34. To satisfy this demand the present invention provides another modular unit, namely, a control module 40 as depicted in FIGS. 5, 7 and 8-10.

The module 40 is comprised of a housing 42 of a size, shape, configuration and design compatible with and complementary to that of the modules 10 and 30 so that when the same are assembled together, as illustrated in FIGS. 7-10, they will convey the appearance of a unitary product of pleasing design. The control module 40, like the power module 30, is invertible so that it may be assembled onto either the left hand side or the right hand side of the humidifier module housing 12, as may be required. In powered humidifier installations, the power module 30 will be mounted on the side of the humidifier module 10 dictated by the requisite direction of air flow, and the control module 40 will be mounted on the other side of the module 10 where it serves, among other functions, to close or block off the unused one of the ports 26 and 28.

Contained within the control module housing 42 are physical, electrical and/or electronic components responsive to the temperature and humidity of the furnace and/or room air to (1) turn the fan motor of the power module on or off and/or to control the speed of the motor and (2) to control the delivery of water to the evaporative element 20, for example, via a solenoid operated water valve 16, thereby to attain and maintain a predetermined degree of relative humidity in the air being conducted by the furnace blower through the space to be heated. The control circuitry for the humidifier preferably comprises a temperature sensor/transmitter unit (thermostat) and a humidity sensor/transmitter unit (humidistat) installed at an appropriate location or locations in the room or space heating and furnace system and, contained within the housing 42, a wireless temperature receiving unit, a wireless humidity receiving unit, a transformer 44, a thermister 46 and suitable switches and electrical/electronic components for operating the solenoid valve 16 and the motor 33 of the fan 34. No hard wiring to the furnace circuits is required. As used herein the term “means for controlling humidity output” means any mechanical, electrical and/or electromechanical device or assembly for controlling humidity output of the humidifier, including but not limited to the aforesaid solenoid operated water valve to selectively provide water to the evaporative element, a blower controller for energizing and/or controlling the speed of the fan motor, and a solenoid operated damper for controlling air flow through the humidifier module.

The control module 40 also preferably includes circuitry and indicators, such as differently colored lights 48, for indicating, for example, that the humidifier is on, i.e., that power is being supplied to the humidifier (green light), that the evaporator 20 needs to be inspected, usually a function of “on” time (red light) and that the timing circuit needs to be reset (blue light), together with a reset button 50 for resetting the timing or count down circuit

The invention thus provides a modular assembly comprised of one, two or three modules to meet all industry, commercial and residential requirements for hot air furnace humidifier applications. Each module need be made and stocked only in a respective number anticipated to be necessary to meet the demand for respective humidifier types or styles.

The objects and advantages of the invention have thus been shown to be attained in a convenient, economical, practical and facile manner.

While preferred embodiments of the invention have been herein illustrated and described, it is to be appreciated that various changes, rearrangements and modifications may be made therein without departing from the scope of the invention as defined by the appended claims.

What is claimed is:

1. A process of making, stocking and/or supplying hot air furnace humidifiers comprising the steps of
providing a selected number of humidifier modules each operable as a bypass humidifier;
providing a lesser number of power modules each including a motor driven fan; and
as needed, combining a power module with a humidifier module for converting a bypass humidifier to a powered humidifier.

2. A process as set forth in claim 1, including the further steps of
providing a smaller number of humidifier control modules than humidifier modules, said control modules having means for controlling humidity output, and
as needed, combining a control module with a humidifier module to form a bypass humidifier with humidity output control.

3. A process as set forth in claim 1 including the further steps of
providing a smaller number of humidifier control modules than humidifier modules, said control modules having means for controlling humidity output, and
as needed, combining a humidifier module, a power module and a control module to form a powered humidifier with humidity output control.

4. A process for adapting air humidifiers to hot air furnaces having air supply and return ducts comprising the steps of
providing humidifier modules each having a housing, an air inlet port to the housing, an air outlet port from the housing, and an evaporator for imparting moisture to air flowing between the inlet and outlet ports,
providing power modules each having a housing, an air inlet port into the housing, an air outlet port form the housing and a motor driven fan within the housing for inducing air to flow between the inlet and outlet ports,
connecting the inlet port of a said humidifier module onto one of the air supply and return ducts of a said furnace, and
selectively connecting the outlet port of said humidifier module to either (a) the other of the air supply and return ducts of the furnace to form a bypass humidifier, or (b) to the inlet of a said power module and connecting the outlet of said power module to said one of the air supply and return ducts of the furnace to form a power humidifier.

5. A process as set forth in claim 4 wherein said humidifier module comprises a housing base and a cover, and the alternative step of connecting the outlet port of said humidifier module to said power module comprises connecting the power module to the housing base of said humidifier module.

6. A process as set forth in claim 4 including the optional step of assembling a control module having means to control humidity output to the humidifier module.

7. A humidifier comprising:
a humidifier module having an air inlet port and an air outlet port and an evaporator between said ports for imparting moisture to air flowing between said ports, and
a power module having an air inlet port, an air outlet port and a motor driven fan between said ports,
said power module being optionally and detachably mountable on said humidifier module with the power module inlet port in fluid communication with the humidifier module outlet port, said motor driven fan being operable to induce air flow through said modules and through said evaporator.

8. A humidifier as set forth in claim 7, wherein said humidifier module includes a housing of a given configuration and design and said power module includes a housing of a configuration and design complementary to the configuration and design of said bypass module housing, said power module housing being detachably mountable on said bypass module housing with the two housings matching one another and imparting the appearance of a unitary product.

9. A humidifier as set forth in claim 7 for assembly with a hot air furnace having a hot air supply duct and a cold air return duct, said humidifier module air inlet port and said power module air outlet port being coupled in fluid communication with one or respective ones of said ducts for humidifying the air flowing through said ducts.

10. A humidifier as set forth in claim 7 including a humidifier control module having means for controlling humidity output optionally and detachably mountable on said humidifier module or the assembly of said humidifier module and said power module.

11. A humidifier as set forth in claim 8 including a humidifier control module detachably mountable on said humidifier module, said control module including a housing of a configuration and design complementary to the configuration and design of the humidifier module housing, said control module housing being detachably mountable on said humidifier module housing with the housings matching one another and imparting the appearance of a unitary product.

12. A humidifier kit for hot air heating systems comprising a humidifier module and a power module as set forth in claim 7,
said humidifier module being adapted for use by itself in bypass humidifier mode for systems accommodating use of a by-pass humidifier,
said power module being optionally mountable on said humidifier module for converting the same to operation in powered humidifier mode for systems requiring a powered humidifier.

13. A humidifier kit as set forth in claim 12 including a humidifier control module detachably mountable on said humidifier module or on the assembly of said humidifier module and said power module.

14. A universal humidifier system for hot air heating systems having an air supply duct and an air return duct comprising
a selected number of humidifier modules each having an air inlet, a pair of air outlets and an evaporator between said inlet and said outlets, and
a lesser number of invertible power modules each having an air inlet, an air outlet and a fan between said inlet and said outlet,
each humidifier module being adapted for use in bypass humidifier mode with its inlet connected with the supply duct, one of its outlets connected with the return duct and the other of its outlets closed off,
each power module being optionally attachable to a humidifier module for use of the two modules in powered humidifier mode with the inlet of the humidifier module connected to the heating system supply duct, the inlet of the power module connected to one of the outlets of the humidifier module, the outlet of the power module connected to the heating system supply duct and the other outlet of the humidifier module closed off.

15. A humidifier system as set forth in claim 14 including a smaller number of invertible control modules each optionally attachable to a humidifier module or an assembly of a humidifier module and a power module, with the control module connected to and closing off said other outlet of the humidifier module.

16. A humidifier system as set forth in claim 14, each humidifier module comprising a housing having front, back and side walls, the air inlet being in the back wall and the air outlets being in respective side walls, said air outlets accommodating air flow to one or the other of the two sides of the housing.

17. A humidifier system as set forth in claim 16, each power module comprising a housing having front, back and side walls, the air outlet being in the back wall and the air inlet being in one of its side walls, each power module being invertible for selectively mounting the power module on either side of the humidifier module housing with the power module inlet connected with a respective one of the humidifier module outlets for accommodating air flow from one side or the other of the humidifier module housing.

18. A humidifier system as set forth in claim 17 including one or more invertible humidifier control modules each having a housing optionally attachable to the side of the humidifier module opposite the side to which the power module is attached and closing off said other one of the humidifier module outlets.

19. A humidifier system as set forth in claim 17, said housings being of comparable and compatible size and design and when assembled imparting the appearance of a unitary product.

20. A humidifier system as set forth in claim 14 wherein said humidifier unit has a housing base and a cover, and wherein said optional attachment of a said power unit to a said humidifier unit comprises attaching the power unit to a side of the housing base and not the cover of the humidifier unit.

21. A humidifier comprising a housing having a base and a moveable cover, an evaporative unit mounted on said base without connection to said cover, and a motor driven fan mounted on said base without connection to said cover,
said motor driven fan being mounted along side and in fluid communication with said evaporative unit for inducing flow of air through said evaporative unit,
said cover being independent of said evaporative unit and said motor driven fan and being independently movable relative to said base for accommodating access to said evaporative unit.
